(19) United States
(12) Patent Application Publication
(10) Pub. No.: US 2019/0161089 A1
(43) Pub. Date: May 30, 2019

(54) CONTROL OF CHASSIS SYSTEMS IN RELATION TO AERODYNAMIC LOADS

(71) Applicant: GM GLOBAL TECHNOLOGY OPERATIONS LLC, Detroit, MI (US)

(72) Inventors: Jason Fahland, Milford, MI (US); Dale Cattell, Milford, MI (US); Michael Hurley, Milford, MI (US); Joshua Auden, Milford, MI (US)

(21) Appl. No.: 15/823,723

(22) Filed: Nov. 28, 2017

(51) Int. Cl. B60W 50/00; B60W 10/22; B60W 10/30

(52) U.S. Cl. CPC B60W 50/0098; B60W 10/22; B60W 10/30; B60W 2710/223; B60W 2520/16; B60W 2520/18; B60W 2710/305; B60W 2520/14

(57) ABSTRACT

An exemplary method of controlling an automotive vehicle includes providing a damper coupled to the vehicle, the damper being provided with magnetorheological fluid and including a magnetic field generator, providing a vehicle sensor configured to measure a vehicle characteristic, providing at least one controller in communication with the actuator, the magnetic field generator, and the vehicle sensor, and in response to a vehicle operating condition being satisfied, determining a vehicle balance and a downforce generation capacity and automatically controlling the magnetic field generator, via the at least one controller, to adjust viscosity of the magnetorheological fluid.

### INTRODUCTION

The present invention relates generally to the field of vehicles and, more specifically, to controlling chassis systems of automotive vehicles in relation to aerodynamic loads.

Recently, actively movable aerodynamic features have been implemented on some vehicles. However, an amount of available downforce generation capacity of a vehicle, even for vehicles not equipped with actively movable aerodynamic features, may exceed a desired vehicle balance. Vehicle performance may be improved if the additional downforce may be applied while maintaining the desired vehicle balance by controlling chassis systems.

### SUMMARY

Embodiments according to the present disclosure provide a number of advantages. For example, embodiments according to the present disclosure enable integrated control of chassis components, including, in some embodiments, a magnetorheological damper, springs, and stabilizer bars to optimize vehicle balance and performance in relation to aerodynamic loads of the vehicle.

In one aspect, a method of controlling an automotive vehicle includes the steps of providing a first component, providing a damper coupled to the first component, the damper being provided with magnetorheological fluid and including a magnetic field generator, providing a vehicle sensor configured to measure a vehicle characteristic, providing at least one controller in communication with the magnetic field generator and the vehicle sensor, and in response to a vehicle operating condition being satisfied, determining a vehicle balance and a downforce generation capacity and automatically controlling the magnetic field generator, via the at least one controller, to adjust viscosity of the magnetorheological fluid.

In some aspects, the method of claim 1, further includes providing a second component, the second component being movably coupled to the first component, providing an actuator coupled to the second component and configured to actuate the second component between a first position and a second position with respect to the first component, and in response to the vehicle operating condition being satisfied, automatically controlling the actuator, via the at least one controller, to move the second component from the first position to the second position.

In some aspects, the second component includes an aerodynamic member and the first component includes a body structure of an automotive vehicle.

In some aspects, determining a vehicle balance includes calculating the vehicle balance with reference to one or more of a setting of the damper, a front commanded downforce, and a rear commanded downforce.

In some aspects, determining a downforce generation capacity includes determining whether additional downforce generation is available and determining a total downforce.

In some aspects, determining the total downforce includes determining a maximum downforce and a damper setting that satisfies a vehicle balance.

In some aspects, the method further includes determining a vehicle pitch and determining a vehicle balance shift, and, if the vehicle pitch exceeds a vehicle pitch condition and the vehicle balance shift exceeds a vehicle balance condition, adjusting the viscosity of the magnetorheological fluid.

In some aspects, the vehicle characteristic includes one or more of a vehicle pitch condition, a vehicle roll condition, a vehicle yaw condition, a chassis position, a steering angle, a throttle position, a brake position, and an active suspension position.

In another aspect, a method of controlling an automotive vehicle includes the steps of providing a first component, providing a suspension system coupled to the first component, the suspension system including a stabilizer bar, providing a vehicle sensor configured to measure a vehicle characteristic, providing at least one controller in communication with the suspension system and the vehicle sensor, and in response to a vehicle operating condition being satisfied, determining a vehicle balance and a stabilizer bar stiffness setting and automatically controlling the suspension system, via the at least one controller, to adjust a stiffness of the stabilizer bar.

In some aspects, the first component includes a body structure of an automotive vehicle.

In some aspects, the vehicle operating condition is satisfied by determining whether one or more of a front and rear aerodynamic load on the automotive vehicle is outside of a predetermined range.

In some aspects, determining the stabilizer bar stiffness setting includes analyzing an aerodynamic load of the automotive vehicle against a stabilizer bar position.

In some aspects, the method further includes determining a downforce generation capacity including determining whether additional downforce generation is available and determining a total downforce.

In some aspects, the method further includes determining whether application of the total downforce satisfies a vehicle balance condition and, if the vehicle balance condition is not satisfied, automatically controlling the suspension system via the at least one controller, to increase the stiffness of the stabilizer bar.

In some aspects, the method further includes determining a lateral acceleration of the automotive vehicle and determining a stabilizer position based on the lateral acceleration and an aerodynamic load of the automotive vehicle.

In some aspects, the method further includes the steps of providing a second component, the first component being movably coupled to the second component, providing an actuator coupled to the second component and configured to actuate the second component between a first position and a second position with respect to the first component, and determining whether application of the total downforce satisfies a vehicle balance condition and, if the vehicle balance condition is not satisfied, automatically controlling the actuator, via the at least one controller, to actuate the second component to the second position from the first position and automatically controlling the suspension system via the at least one controller, to increase the stiffness of the stabilizer bar.

In yet another aspect, an automotive vehicle includes a body having an exterior surface, a suspension system coupled to the body, the suspension system including a stabilizer bar and a damper, the stabilizer bar configured to rotate with respect to a stabilizer bar axis of rotation, and at least one controller in communication with the suspension system, the at least one controller being configured to control the damper to adjust a stiffness of the suspension system and to adjust a degree of rotation of the stabilizer bar, wherein the stiffness of the suspension system and the degree of rotation of the stabilizer bar is controlled based on an aerodynamic load of the automotive vehicle.

In some aspects, the automotive vehicle further includes at least one vehicle sensor configured to measure a vehicle characteristic.

In some aspects, the automotive vehicle further includes an aerodynamic member movably coupled to the exterior surface, the aerodynamic member having a first position with respect to the exterior surface and a second position with respect to the exterior surface, the first position presenting a distinct aerodynamic profile from the second position, and an actuator coupled to the aerodynamic member and configured to actuate the aerodynamic member between the first position and the second position, wherein the at least one controller is configured to control the actuator to move the aerodynamic member from the first position to the second position.

In some aspects, the vehicle characteristic includes one or more of a vehicle pitch condition, a vehicle roll condition, a vehicle yaw condition, a chassis position, a steering angle, a throttle position, and a brake position.

### BRIEF DESCRIPTION OF THE DRAWINGS

The present disclosure will be described in conjunction with the following figures, wherein like numerals denote like elements.

FIG. 1 is a schematic illustration of a vehicle according to an embodiment of the present disclosure.

FIG. 2 is a schematic representation of a magnetorheological damper according to an embodiment of the present disclosure.

FIG. 3 is a schematic representation of a control system for an aerodynamic system according to an embodiment of the present disclosure.

FIG. 4 is a schematic representation of components of a suspension system according to an embodiment of the present disclosure.

FIG. 5 is a flowchart representation of a method of controlling an aerodynamic control system according to an embodiment of the present disclosure.

FIG. 6 is a flowchart representation of another method of controlling an aerodynamic control system according to an embodiment of the present disclosure.

FIG. 7 is a flowchart representation of another method of controlling an aerodynamic control system according to an embodiment of the present disclosure.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

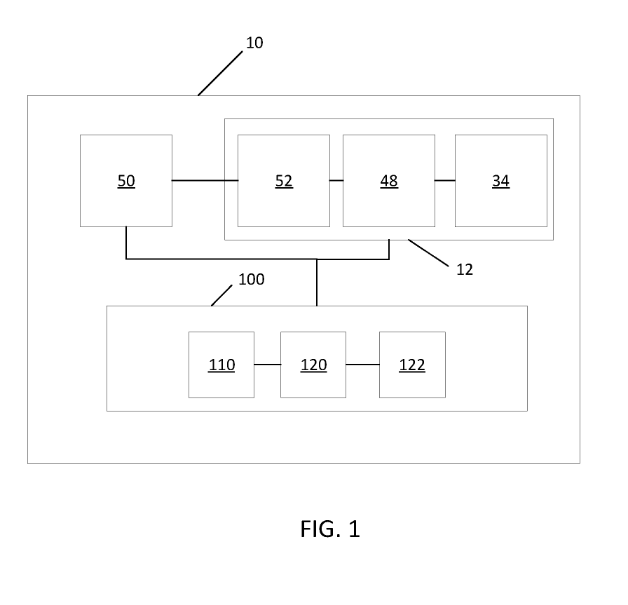

Referring now to FIG. 1, an automotive vehicle 10 having an aerodynamic control system 12, a magnetorheological (MR) damper 50, and a suspension system 100 according to the present disclosure is schematically illustrated.

Continuing with FIG. 1, in some embodiments, the aerodynamic control system 12 also includes at least one aerodynamic member 34. In some embodiments, the aerodynamic member is a wing-shaped spoiler, however, the aerodynamic member 34 may be any shape configured to generate aerodynamic downforce. “Wing-shaped” as used herein refers to an object having a shape of a wing, i.e., a fin having an airfoil shape defined by a streamlined cross-sectional shape configured to produce lift or downforce. The term “spoiler” means an aerodynamic device capable of disrupting air movement across the vehicle body while the vehicle 10 is in motion, thereby reducing drag and/or inducing an aerodynamic downforce F on the vehicle 10. The term “downforce” means a force component that is perpendicular to the direction of relative motion of the vehicle 10, i.e., in the longitudinal direction, toward the road surface. The aerodynamic member 34 may be formed from a suitably rigid but low mass material, such as an engineered plastic or aluminum, for structural stability.

In various embodiments considered within the scope of the present disclosure, the aerodynamic member 34 can include one or more of a spoiler or a wing disposed at any location along a top of the vehicle 10, a dive wing disposed at any location along a corner of the vehicle 10, a gurney flap disposed at any location along the fore portion of the vehicle 10 or disposed on a spoiler, a front splitter disposed at any location along the fore portion of the vehicle 10, a front air dam disposed at any location along the fore portion of the vehicle 10, other aerodynamic members, or combination thereof. Each of the aerodynamic members 34 can include one or more of the features discussed herein for the single aerodynamic member 34.

The aerodynamic control system 12 further includes an actuator 48 coupled to the aerodynamic member 34. The actuator 48 is configured to move the aerodynamic member 34 between the first and second positions. The actuator 48 can be coupled to the aerodynamic member 34 in any suitable location to move the aerodynamic member 34. The actuator 48 can include a motor, a solenoid, an arm and/or any other suitable apparatus to move the aerodynamic member 34 to the desired position.

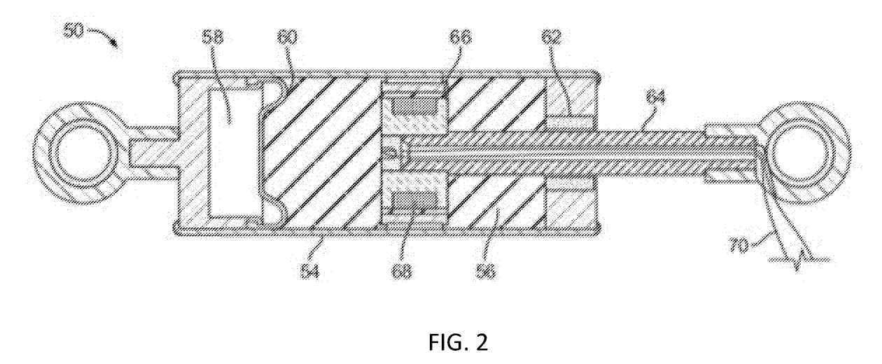

In some embodiments, the aerodynamic control system 12 further includes a MR damper 50 or is, in some embodiments, electrically connected to the MR damper. Various designs of MR dampers are known. An exemplary MR damper 50 is illustrated in FIG. 2; however, any known MR damper design may be implemented in embodiments according to the present disclosure.

The MR damper 50 includes a housing 54 filled with a quantity of MR fluid 56. MR fluid generally consists of a carrier fluid such as oil, water, or glycol, provided with ferrous particles such as carbonyl iron. The housing 50 has a closed end provided with an accumulator 58 and a diaphragm 60 and an open end provided with an annular seal 62. A piston 64 passes through the seal 62 and is retained at least partially within the housing 54 and arranged to slide relative to the housing 54. The diaphragm 60 and accumulator 58 are provided to accommodate changes in volume arising due to sliding motion of the piston 64. A fluid orifice 66 is provided through a head of the piston 64, such that MR fluid 56 may pass through the orifice 66 as the piston 64 slides relative to the housing 54. An electromagnetic coil 68 is provided on the head of the piston 64 and coupled to electrodes 70.

When the electrodes 70 are energized, current is supplied to the coil 68 and a magnetic field is thereby generated. In response to the magnetic field, ferrous particles in the MR fluid 56 are aligned and the viscosity of the MR fluid 56 is increased. The extent to which the ferrous particles in the MR fluid 56 are aligned, and hence the viscosity of the MR fluid 56, may be varied by modifying the current applied to the electrodes 70. The MR damper 50 thereby provides a controllable quantity of damping force, resisting motion of the piston 64.

In some embodiments, the actuator 48 and MR damper 50 are under the control of a controller 52. While depicted as a single unit, the controller 52 may include one or more additional controllers collectively referred to as a “controller.” The controller 52 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller in controlling the engine or vehicle.

The controller 52 is programmed to control the actuator 48 to move the aerodynamic member 34 between first and second positions in response to satisfaction of various operating conditions. As an example, the controller 52 may be programmed to control the actuator 48 to move the aerodynamic member 34 to increase downforce in response to a turning operating condition being satisfied.

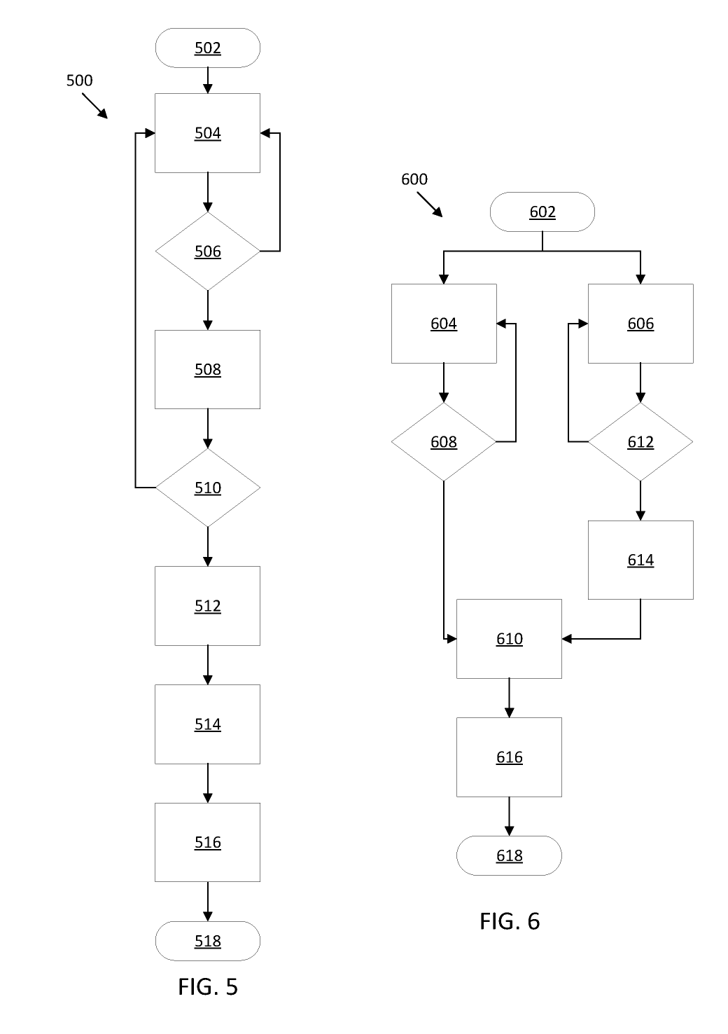

Furthermore, the controller 52 is programmed to control the MR damper 50, as will be discussed in further detail below with respect to FIGS. 5-7. Briefly speaking, the controller 52 may selectively control the MR damper 50 to increase or decrease the viscosity of the MR fluid 66.

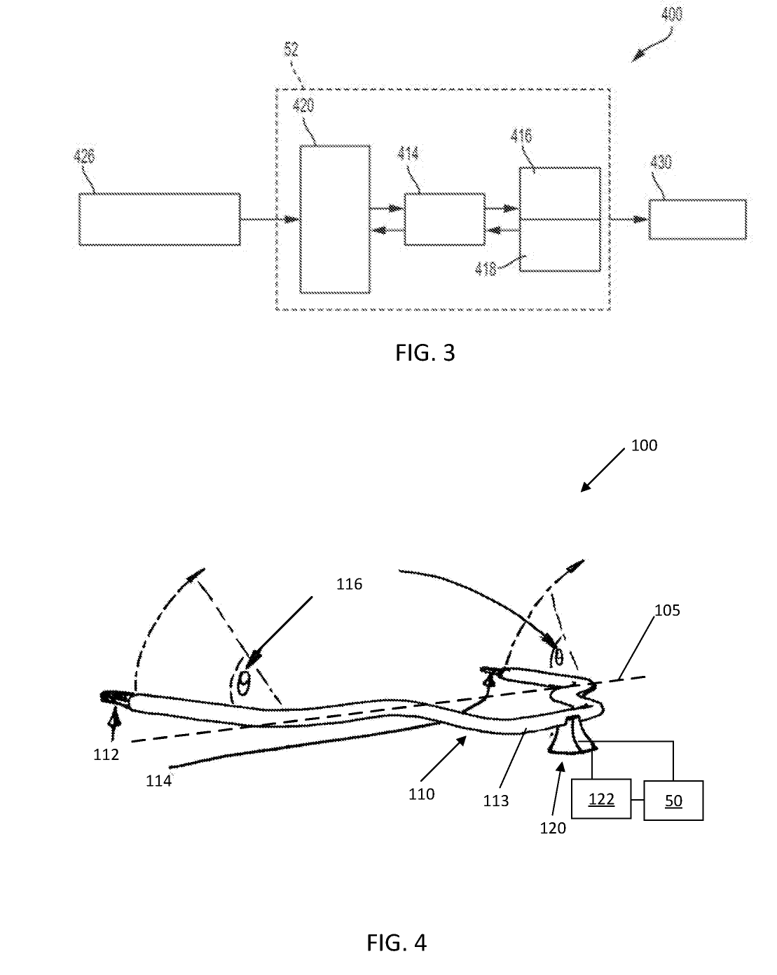

FIG. 3 illustrates an exemplary control system 400 for controlling an aerodynamic system. A processor/controller device, such as the controller 52, includes a central processing unit (CPU) 414 coupled to memory devices 416 and 418, which can include such memory as random access memory (RAM) 416, non-volatile read only memory (NVROM) 418, and possibly other mass storage devices. The CPU 414 is coupled through an input/output (I/O) interface 420 to at least one of a plurality of sensors 426, of the vehicle 10. The sensors 426 are configured to measure various operational parameters of the vehicle and provide data on environmental conditions along a projected path of travel of the vehicle, as discussed herein. In some embodiments, the CPU 414 is coupled through the I/O interface 420 to an inertial measurement unit (IMU) including one or more sensors 426. The controller 52 generates one or more control signals and transmits the control signals to one or more actuators 430, including, for example and without limitation, the actuator 48 configured to control the aerodynamic member 34, the MR damper 50, and an active stabilizer system, as discussed in greater detail herein.

Stabilizer bar suspension systems are present in almost every automobile sold today. They are used to tune ride, handling, and steering and maintain vehicle roll stability during lateral movements. The aerodynamic force that is reacted through the vehicle suspension varies with speed and the position of the aerodynamic member 34. In a traditional suspension system, the rates of change of the springs and stabilizer bars that react to the aerodynamic force are fixed. This results in a compromise between low speed/low aerodynamic load and high speed/high aerodynamic load and stabilizer bar reaction rates. FIG. 4 illustrates a stabilizer bar suspension system 100 for a vehicle, such as vehicle 10. In some embodiments, the system 100 includes a stabilizer bar 110. The stabilizer bar 110 helps to reduce the body roll of the vehicle 10 during fast cornering or over road irregularities. The stabilizer bar 110 connects opposite (left/right) wheels together through short lever arms linked by a torsion spring. The stabilizer bar 110 increases the roll stiffness of the suspension system 100, that is, its resistance to roll in turns, independent of its spring rate in the vertical direction.

In some embodiments, the stabilizer bar 110 is a torsion spring that resists body roll motions. It is usually constructed from a cylindrical steel bar formed into a “U” shape that connects to the vehicle body at two points, and at the left and right sides of the suspension system 100. If the left and right vehicle wheels move together, the stabilizer bar 110 rotates about its mounting points. If the wheels move relative to each other, the stabilizer bar 110 is subjected to torsion and forced to twist.

In some embodiments, the stabilizer bar 110 is bent either outward or inward from a center of rotation. As shown in FIG. 4, outward sections 112, 114 rotate either upward or downward about the axis 105 in response to, for example and without limitation, compressive wheel forces or total load changes due to downforce adjustments as a result of a change in position of the aerodynamic member 34. As shown in FIG. 4, the outward sections 112, 114 rotate upward an angle 116 due to the wheels 116 compressing upwards. As a result of the upward rotation of the sections 112, 114, a center section 113 rotates downward about the axis 105.

In some embodiments, the suspension system 100 also includes a spring member 120. The center section 113 engages the spring member 120 to improve the spring and roll rate response of the suspension system 100 from high and low downforce vehicle conditions, allowing low suspension system 100 deflection at high speeds and/or aerodynamic loads and a softer spring response at lower speeds and/or aerodynamic loads. In some embodiments, the spring member 120 is a jounce bumper, a mechanical spring such as a helical or leaf spring, or a simple polymer and/or rubber element configured to compress or stretch in response to a load on the stabilizer bar, for example and without limitation.

In some embodiments, the suspension system 100 is an active stabilization system that includes a controller 122. In some embodiments, the suspension system 100 is electronically coupled to the controller 52. In other embodiments, the suspension system 100 includes a separate active roll bar controller 122. In some embodiments, the controller 52 or the controller 122 is electronically coupled to the spring member 120 to control a stiffness of the suspension system 100 and control rotation of the stabilizer bar 110 about the axis 105. In some embodiments, the suspension system 100 includes one or more MR dampers 50, discussed herein. In some embodiments, the damping provided by the MR damper is adjusted by a controller, such as the controller 122 of the active suspension system or the controller 52 of the aerodynamic control system, to maintain or achieve a desired vehicle balance while optimizing the amount of downforce applied to the front and/or rear of the vehicle to improve vehicle performance.

Referring now to FIG. 5, a method 500 of controlling an aerodynamic control system according to the present disclosure is illustrated in flowchart form. In some embodiments, a controller of the aerodynamic control system sends firmness requests to an MR damper based on vehicle dynamics inputs and aerodynamic load inputs. In some embodiments, the stiffness of the MR damper is continuously adjusted based on the aerodynamic load, thereby achieving a higher overall amount of downforce while satisfying the desired vehicle balance through adjustment of the MR damper stiffness. In an exemplary embodiment, the aerodynamic control system and the MR damper are arranged generally similar to that illustrated in FIGS. 1-4, and the algorithm illustrated in FIG. 5 is performed by a controller generally similar to the controller 52. The order of operation of the method 500 is not limited to the sequential execution as illustrated in FIG. 5 but may be performed in one or more varying orders, or steps may be performed simultaneously, as applicable in accordance with the present disclosure.

The method 500 begins at 502 and proceeds to 504. At 504, the controller, such as the controller 52, receives vehicle characteristic data. The vehicle characteristic data includes, in some embodiments, data on vehicle pitch and pitch gradient, roll and roll gradient, yaw and yaw gradient, vehicle acceleration, chassis position including vehicle ride height, MR damper position, commanded aerodynamic load/balance, vehicle balance, steering angle information, throttle and brake position, and active suspension system position, for example and without limitation. The vehicle characteristic data is obtained, in some embodiments, from one or more vehicle sensors 426. The vehicle sensors 426 are, in some embodiments, part of a Semi Active Damping System (SADS), an inertial measurement unit (IMU), or are any other type of vehicle sensor.

Next, at 506, a determination is made of whether a vehicle operating condition is satisfied. As a non-limiting example, the vehicle operating condition may correspond to a determination that the vehicle is undergoing a turning maneuver, or any other operating condition in which actuation of an aerodynamic member or a MR damper is desirable. If the determination made at 506 is negative, the method 500 returns to 504 and proceeds as discussed herein.

If the determination made at 506 is positive, the controller 52 calculates the vehicle balance and the total aerodynamic downforce generation capacity during the maneuver, at 508. Calculation of the vehicle balance includes, for example and without limitation, influence on the vehicle balance from the MR damper setting and the front and rear available and/or commanded, aerodynamic downforce generated by the position of the aerodynamic member.

From 508, the method 500 proceeds to 510. At 510, a determination is made of whether extra downforce generation capacity is available. If the determination at 510 is negative, the method 500 returns to 504 and proceeds as discussed herein.

When there is extra aerodynamic downforce generation capacity available that normally would not be used as applying the extra downforce would exceed a predetermined aerodynamic balance, the method 500 proceeds to 512 and the controller will determine the highest total downforce that may be applied for a desired and achievable vehicle balance, considering the dampening capacity of the MR damper that may be used to help achieve the desired vehicle balance. In some embodiments, the total downforce that may be applied is obtained from a lookup table that relates downforce and vehicle balance.

Next, at 514, the controller determines the area of available aerodynamic force. In some embodiments, this area is the total area of one or more aerodynamic members of the vehicle that may be adjusted to increase the aerodynamic downforce applied to the vehicle. In some embodiments, the controller determines how much downforce to apply to the front and/or the rear of the vehicle, based on the amount of aerodynamic force available, the MR damper limits, and the vehicle operating condition, for example and without limitation.

At 516, the positions of both the aerodynamic member and the MR damper are adjusted based on the calculated area of available aerodynamic force. In a non-limiting example, reference to a tunable calibration table enables a determination of an amount of downforce to be added to the front of the vehicle by adjusting the position of the aerodynamic member while also adjusting a setting of a first MR damper to increase damping at the front of the vehicle and adjusting a setting of a second MR damper to decrease damping at the rear of the vehicle. In another non-limiting example, reference to a tunable calibration table enables a determination of an amount of downforce to be added to the rear of the vehicle by adjusting the position of the aerodynamic member while also adjusting a setting of the second MR damper to increase damping at the rear of the vehicle and adjusting a setting of the first MR damper to decrease damping at the front of the vehicle.

Each incremental change in aerodynamic force that is enabled by altering the MR damping could enable an adjustment on the opposite actuator of the aerodynamic member. For example, if the front aerodynamic force is able to increase in parallel with an MR damping increase in the front and an MR damping decrease in the rear, it may be possible to add rear downforce to the vehicle as well, the purpose being to add as much downforce as possible while still satisfying vehicle balance. To capture this, the controller determines the maximum amount of front/rear downforce and maximum additional MR damping capacity available at that moment. The controller calculates the potential increase in front or rear downforce/damping, and determines a control signal to adjust the positions of the MR damper and the aerodynamic member to achieve the maximum downforce according to tunable gains/filters. In some embodiments, the controller analyzes adjustments to one or more aerodynamic members that affect the downforce applied to the front of the vehicle, one or more aerodynamic members that affect the downforce applied to the rear of the vehicle, and one or more MR dampers that affect the stiffness of the front and/or rear of the vehicle, thus actively controlling the aerodynamic force and stiffness at both ends of the vehicle to achieve the maximum overall amount of downforce.

The method 500 then proceeds to 516 and the controller generates control signals to adjust the position of the aerodynamic member and the setting of the one or more MR dampers to positions and settings corresponding to a predetermined base calibration, once the vehicle is no longer subject to the vehicle operating condition. That is, in some embodiments, the controller uses decay filters and a vehicle balance calibration table to determine the MR damping request and the aerodynamic member position request that will return the vehicle to a vehicle balance setting consistent with a standard operating condition, such as driving on a flat, level roadway, for example and without limitation. The method 500 then proceeds to 518 and ends.

In some embodiments, adjustment of a position of the MR damper is accomplished simultaneously with an adjustment to the position of the aerodynamic member to increase the amount of downforce deployed to the vehicle in order to achieve a higher overall amount of downforce while still satisfying the desired vehicle balance. In some embodiments, the adjustment of a setting of the MR damper and a position of the aerodynamic member by an integrated controller improves the overall performance of the vehicle above what is achievable by standalone MR damping and active aerodynamic control systems.

While the method 500 is discussed in relation to a vehicle having an aerodynamic control system 12, in some embodiments, the vehicle 10 does not include an adjustable aerodynamic member 34 and adjustment of the MR damper is accomplished by a vehicle controller to compensate for aerodynamic forces generated by the vehicle during operation.

Referring now to FIG. 6, a method 600 of controlling an aerodynamic control system according to the present disclosure is illustrated in flowchart form. In some embodiments, a controller of the aerodynamic control system sends firmness requests to an MR damper to request an increase or decrease in pitch and heave control using both feed-forward and feed-back control. In some embodiments, the stiffness of the MR damper is increased to react to sudden large changes in aerodynamic loads, thereby reducing unwanted suspension movement while maintaining optimal overall grip and more desirable vehicle ride characteristics. In an exemplary embodiment, the aerodynamic control system and the MR damper are arranged generally similar to that illustrated in FIGS. 1-4, and the algorithm illustrated in FIG. 6 is performed by a controller generally similar to the controller 52. The order of operation of the method 600 is not limited to the sequential execution as illustrated in FIG. 6 but may be performed in one or more varying orders, or steps may be performed simultaneously, as applicable in accordance with the present disclosure.

The method 600 begins at 602 and proceeds along two simultaneous paths, to 604 and 606. At 604, the controller, such as the controller 52, receives vehicle characteristic data. The vehicle characteristic data includes, in some embodiments, data on vehicle pitch and pitch gradient, roll and roll gradient, yaw and yaw gradient, vehicle acceleration, chassis position including vehicle ride height, MR damper position, and active suspension system position, for example and without limitation. The vehicle characteristic data is obtained, in some embodiments, from one or more vehicle sensors 426. The vehicle sensors 426 are, in some embodiments, part of a Semi Active Damping System (SADS), an inertial measurement unit (IMU), or are any other type of vehicle sensor.

At 606, along a feedforward path of the algorithm, the controller 52 determines a commanded downforce gradient and transmits a position adjustment to the actuator 48 coupled to the aerodynamic member 34 to adjust a position of the aerodynamic member 34 to deliver the commanded downforce.

From 604 and 606, the method 600 proceeds to 608 and 612, respectively. At 608, the controller determines whether a first vehicle operating condition is satisfied. As a non-limiting example, the first vehicle operating condition may correspond to a determination that a vehicle pitch and/or a vehicle pitch gradient is greater than an acceptable range. The acceptable range varies based on the vehicle type and configuration, among other considerations. In some embodiments, the first vehicle operating condition may correspond to a determination that the vehicle is undergoing a braking maneuver, or any other operating condition in which the vehicle pitch and/or pitch gradient affects vehicle stability.

If the determination made at 608 is negative, no action is taken and the method 600 returns to 604 and proceeds as discussed herein. If the determination made at 608 is positive, the method 600 proceeds to 610.

As the controller is receiving sensor information as feedback on one or more vehicle operating conditions, the aerodynamic member is positioned by the aerodynamic control system to apply available downforce to the vehicle, as shown at 606. Next, the controller at 612 determines whether a second vehicle operating condition is satisfied. As a non-limiting example, the second vehicle operating condition may correspond to a determination that a downforce command gradient is greater than a first predetermined threshold and/or a determination that a balance shift of the vehicle is greater than a second predetermined threshold. In some embodiments, the first and second predetermined thresholds vary based on the vehicle type and configuration, among other considerations. In some embodiments, the first and second thresholds correspond to values obtained from one or more lookup tables relating the downforce command gradient and the vehicle balance shift.

If the determination made at 612 is negative, no action is taken and the method 600 returns to 606 and proceeds as discussed herein. If the determination made at 612 is positive, the method 600 proceeds to 614. At 614, a damper firmness setting is obtained from a lookup table that relates the downforce command gradient and the resulting vehicle aerodynamic balance change resulting from the downforce command. The damper firmness setting is compared, at 610, with the pitch and/or pitch gradient data and may be refined to an adjusted damper firmness setting to resolve any inaccuracies in the damper firmness setting obtained at 614.

From 610, the method 600 proceeds to 616 and the MR damper is controlled to the damper firmness setting refined, if necessary, at 610. The method 600 then proceeds to 618 and ends.

In some embodiments, the method 600 operates continuously. In some embodiments, the method 700 operates when a trigger condition is identified, such as, for example and without limitation, detection of a vehicle braking event.

The method 600 is used, in some embodiments, during hard vehicle braking events to improve vehicle stability. The addition of downforce during hard braking events allows the vehicle to decelerate quickly, but may also cause the front of the vehicle to become overloaded and possibly bounce off the road surface. This algorithm momentarily stiffens the front vehicle damper(s), improving vehicle stability when downforce is applied. The method 600 combines a feedforward process (606, 612, 614) with a feedback process (604, 608) to both react quickly to a vehicle event, such as a hard braking event and compensate for the additional applied downforce with damper stiffness adjustments. The feedforward and feedback aspects of the method 600 prepare the suspension system 100 for sudden changes in load, in particular to sudden changes to only one axle of the vehicle 10, in order to mitigate excessive pitch and/or heave caused by a change in aerodynamic load forces applied to the vehicle 10.

While the method 600 is discussed in relation to a vehicle having an aerodynamic control system 12, in some embodiments, the vehicle 10 does not include an adjustable aerodynamic member 34 and adjustment of the MR damper is accomplished by a vehicle controller to compensate for aerodynamic forces generated by the vehicle during operation.

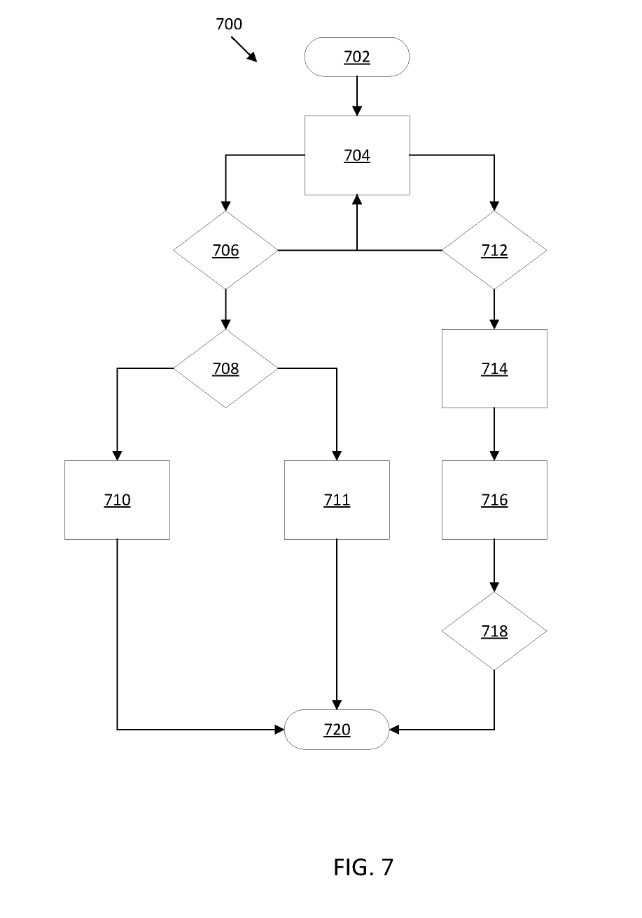

Referring now to FIG. 7, a method 700 of controlling an aerodynamic control system according to the present disclosure is illustrated in flowchart form. In some embodiments, a controller of the aerodynamic control system sends stiffness and/or rotation limit requests to an active suspension system based on vehicle dynamics inputs and aerodynamic load inputs. In some embodiments, the stiffness and/or rotation limit of the stabilizer bar of the active suspension system is continuously adjusted based on the aerodynamic load, thereby altering the font and/or rear ride frequency and roll stiffness of the vehicle to optimize vehicle stability for a given aerodynamic load. For vehicles including an aerodynamic member, the aerodynamic force that is reacted through the vehicle suspension varies with speed and the position of the aerodynamic member. For vehicles that do not include an aerodynamic member, the aerodynamic force that is reacted through the vehicle suspension varies with speed and maneuvers of the vehicle, such as turns or hard braking. However, if the rates of the spring and stabilizer bars of a traditional suspension system that react the aerodynamic force loads are fixed, a compromise is made between low speed/low aerodynamic load and high speed/high aerodynamic load ideal spring and bar rates. The methods discussed herein optimize the spring and roll rates of an active suspension system from high to low downforce vehicle conditions, allowing low suspension deflection at high vehicle speeds and aerodynamic loads and a softer spring and/or bar response at low vehicle speeds and aerodynamic loads.

Additionally, under some vehicle operating conditions, additional aerodynamic downforce may be available at either the front or rear of the vehicle but cannot be applied without adversely affecting the vehicle balance. Under these conditions, a stiffness of a stabilizer bar of the suspension system located at the end of the vehicle having the additional available downforce can be increased, allowing the additional downforce to be applied while satisfying a desired vehicle balance, resulting in an increase in overall performance of the vehicle.

In an exemplary embodiment, the aerodynamic control system and the active suspension system are arranged generally similar to that illustrated in FIGS. 1-4, and the algorithm illustrated in FIG. 7 is performed by a controller generally similar to the controller 52 or to a controller generally similar to the controller 122. The order of operation of the method 700 is not limited to the sequential execution as illustrated in FIG. 7 but may be performed in one or more varying orders, or steps may be performed simultaneously, as applicable in accordance with the present disclosure.

The method 700 begins at 702 and proceeds to 704. At 704, the controller, such as the controller 52, receives vehicle characteristic data. The vehicle characteristic data includes, in some embodiments, data on vehicle pitch and pitch gradient, roll and roll gradient, yaw and yaw gradient, vehicle acceleration, chassis position including vehicle ride height, MR damper position, commanded aerodynamic load/balance to the front and/or rear of the vehicle, vehicle balance, steering angle information, throttle and brake position, and active suspension system position, for example and without limitation. The vehicle characteristic data is obtained, in some embodiments, from one or more vehicle sensors 426. The vehicle sensors 426 are, in some embodiments, part of a Semi Active Damping System (SADS), an inertial measurement unit (IMU), or are any other type of vehicle sensor.

From 704, the method 700 proceeds along two simultaneous paths. At 706, the controller determines whether a first vehicle operating condition is satisfied. As a non-limiting example, the first vehicle operating condition may correspond to a determination that one or both of the front and rear aerodynamic loads on the vehicle is outside of an acceptable range. The acceptable range varies based on the vehicle type and configuration, among other considerations.

If the determination made at 706 is negative, no action is taken and the method 700 returns to 704 and proceeds as discussed herein. If the determination made at 706 is positive, the method 700 proceeds to 708.

At 708, the lateral acceleration of the vehicle is determined from data received from the vehicle sensors 426. If the determination at 708 is that the vehicle is operating under low lateral acceleration, the method proceeds to 710. At 710, an amount of rotation of the stabilizer bar of the suspension system is determined, in some embodiments, from a lookup table relating aerodynamic load to stabilizer bar position. Rotation of the stabilizer bar is restricted to control the stabilizer bar contribution to ride frequency. The controller generates the stabilizer bar position control signal and, in some embodiments, directly controls the position of the front and/or rear stabilizer bar of the active suspension system. In some embodiments, the controller transmits the control signal to a separate controller of the active suspension system.

If the determination at 708 is that the vehicle is operating under high lateral acceleration, the method proceeds to 711. At 711, an amount of rotation of the stabilizer bar of the suspension system is determined, in some embodiments, from a lookup table relating aerodynamic load to stabilizer bar position and understeer gradient. If the vehicle is operating at high lateral acceleration, adjustments to or limits on the rotation of the stabilizer bar are made or imposed on both a front and rear stabilizer bar based on general vehicle dynamics information, such as yaw rate error and understeer gradient, acquired, for example, from the plurality of sensors 426. The controller generates the stabilizer bar position control signal and, in some embodiments, directly controls the position of the front and/or rear stabilizer bar of the active suspension system. In some embodiments, the controller transmits the control signal to a separate controller of the active suspension system.

From 711, the method 700 proceeds to 720 and ends.

Along a parallel path, at 712, the controller determines whether a second vehicle operating condition is satisfied. As a non-limiting example, the second vehicle operating condition may correspond to a determination that the aerodynamic member may be positioned such that an amount of available downforce is available and cannot be applied to the front and/or rear of the vehicle to maintain a desired vehicle balance. If the determination at 712 is negative, that is, that the aerodynamic member cannot be positioned to provide additional downforce, or that the available downforce can be applied to the front and/or rear of the vehicle while satisfying the desired vehicle balance, no action is taken with regard to changing a stiffness or rotation limit of the stabilizer bar and the method 700 returns to 704 and proceeds as discussed herein.

If the determination at 712 is positive, that is, that the aerodynamic member may be positioned such that an amount of downforce is available to be applied to the front and/or rear of the vehicle but adjusting the aerodynamic member to apply the downforce would result in an undesired vehicle balance, the method 700 proceeds to 714. At 714, the controller generates a stabilizer bar stiffness control signal and, in some embodiments, directly controls the stiffness of the stabilizer bar of the active suspension system. In some embodiments, the controller transmits the control signal to a separate controller of the active suspension system. The stiffness of the stabilizer bar is increased at either the front or rear of the vehicle depending on which end of the vehicle has excess aerodynamic load capacity.

Next, at 716, the controller adjusts a position of the aerodynamic member to maximize the amount of downforce applied to the vehicle at a desired vehicle balance. From 716, the method 700 proceeds to 718. At 718, the controller generates control signals to adjust the position of the aerodynamic member and the stiffness and/or rotation limitation of the stabilizer bar of the suspension system to positions and settings corresponding to a predetermined base calibration, if the controller determines the vehicle is no longer undergoing a maneuver in which adjustment of the active suspension system and/or a position of the aerodynamic member is desired. That is, in some embodiments, the controller uses decay filters and a vehicle balance calibration table to determine the active suspension settings and the aerodynamic member position request that will return the vehicle to a vehicle balance setting consistent with a standard operating condition, such as driving on a flat, level roadway, for example and without limitation. The method 700 then proceeds to 720 and ends.

In various embodiments according to the present disclosure, the aerodynamic control system can be utilized in a vehicle application or a non-vehicle application. Non-limiting examples of vehicular embodiments include cars, racing vehicles, trucks, off-road vehicles, motorcycles, aircrafts, farm equipment or any other suitable movable platform. Vehicular embodiments may include autonomously driven vehicles or conventional human-controlled vehicles. Non-limiting examples of the non-vehicular embodiments include machines, farm equipment or any other suitable non-vehicle device.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to form additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way, required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 3” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 3,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components. Such example devices may be on-board as part of a vehicle computing system or be located off-board and conduct remote communication with devices on one or more vehicles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling an automotive vehicle, comprising:
providing a first component;
providing a damper coupled to the first component, the damper being provided with magnetorheological fluid and including a magnetic field generator;
providing a vehicle sensor configured to measure a vehicle characteristic;
providing at least one controller in communication with the magnetic field generator, and the vehicle sensor; and
in response to a vehicle operating condition being satisfied, determining a vehicle balance and a downforce generation capacity and automatically controlling the magnetic field generator, via the at least one controller, to adjust viscosity of the magnetorheological fluid.

2. The method of claim 1, further comprising
providing a second component, the second component being movably coupled to the first component;
providing an actuator coupled to the second component and configured to actuate the second component between a first position and a second position with respect to the first component; and
in response to the vehicle operating condition being satisfied, automatically controlling the actuator, via the at least one controller, to move the second component from the first position to the second position.

3. The method of claim 2, wherein the second component includes an aerodynamic member and the first component includes a body structure of the automotive vehicle.

4. The method of claim 1, wherein determining a vehicle balance comprises calculating the vehicle balance with reference to one or more of a setting of the damper, a front commanded downforce, and a rear commanded downforce.

5. The method of claim 1, wherein determining a downforce generation capacity comprises determining whether additional downforce generation is available and determining a total downforce.

6. The method of claim 5, wherein determining the total downforce comprises determining a maximum downforce and a damper setting that satisfies the vehicle balance.

7. The method of claim 1, further comprising determining a vehicle pitch and determining a vehicle balance shift, and, if the vehicle pitch exceeds a vehicle pitch condition and the vehicle balance shift exceeds a vehicle balance condition, adjusting the viscosity of the magnetorheological fluid.

8. The method of claim 1, wherein the vehicle characteristic includes one or more of a vehicle pitch condition, a vehicle roll condition, a vehicle yaw condition, a chassis position, a steering angle, a throttle position, a brake position, and an active suspension position.

9. A method of controlling an automotive vehicle, comprising:
providing a first component;
providing a suspension system coupled to the first component, the suspension system including a stabilizer bar;
providing a vehicle sensor configured to measure a vehicle characteristic;
providing at least one controller in communication with the suspension system and the vehicle sensor; and
in response to a vehicle operating condition being satisfied, determining a vehicle balance and a stabilizer bar stiffness setting and automatically controlling the suspension system, via the at least one controller, to adjust a stiffness of the stabilizer bar.

10. The method of claim 9, wherein the first component includes a body structure of an automotive vehicle.

11. The method of claim 9, wherein the vehicle operating condition is satisfied by determining whether one or more of a front and rear aerodynamic load on the automotive vehicle is outside of a predetermined range.

12. The method of claim 9, wherein determining the stabilizer bar stiffness setting comprises analyzing an aerodynamic load of the automotive vehicle against a stabilizer bar position.

13. The method of claim 9, further comprising determining a downforce generation capacity including determining whether additional downforce generation is available and determining a total downforce.

14. The method of claim 13, further comprising determining whether application of the total downforce satisfies a vehicle balance condition and, if the vehicle balance condition is not satisfied, automatically controlling the suspension system via the at least one controller, to increase the stiffness of the stabilizer bar.

15. The method of claim 13, further comprising determining a lateral acceleration of the automotive vehicle and determining a stabilizer position based on the lateral acceleration and an aerodynamic load of the automotive vehicle.

16. The method of claim 13, further comprising
providing a second component, the first component being movably coupled to the second component;
providing an actuator coupled to the second component and configured to actuate the second component between a first position and a second position with respect to the first component; and
determining whether application of the total downforce satisfies a vehicle balance condition and, if the vehicle balance condition is not satisfied, automatically controlling the actuator, via the at least one controller, to actuate the second component to the second position from the first position and automatically controlling the suspension system via the at least one controller, to increase the stiffness of the stabilizer bar.

17. An automotive vehicle comprising:
a body having an exterior surface;
a suspension system coupled to the body, the suspension system including a stabilizer bar and a damper, the stabilizer bar configured to rotate with respect to a stabilizer bar axis of rotation; and
at least one controller in communication with the suspension system, the at least one controller being configured to control the damper to adjust a stiffness of the suspension system and to adjust a degree of rotation of the stabilizer bar;
wherein the stiffness of the suspension system and the degree of rotation of the stabilizer bar is controlled based on an aerodynamic load of the automotive vehicle.

18. The automotive vehicle of claim 17, further comprising at least one vehicle sensor configured to measure a vehicle characteristic.

19. The automotive vehicle of claim 17, further comprising
an aerodynamic member movably coupled to the exterior surface, the aerodynamic member having a first position with respect to the exterior surface and a second position with respect to the exterior surface, the first position presenting a distinct aerodynamic profile from the second position; and
an actuator coupled to the aerodynamic member and configured to actuate the aerodynamic member between the first position and the second position;
wherein the at least one controller is configured to control the actuator to move the aerodynamic member from the first position to the second position.

20. The automotive vehicle of claim 18, wherein the vehicle characteristic includes one or more of a vehicle pitch condition, a vehicle roll condition, a vehicle yaw condition, a chassis position, a steering angle, a throttle position, and a brake position.
